(19) United States
(12) Patent Application Publication
(10) Pub. No.: US 2017/0349673 A1
(43) Pub. Date: Dec. 7, 2017

(54) Use of Cyclodextrins to Increase the Surface Energy of Polymer Plastics

(71) Applicant: Lisa Draexlmaier GmbH, Vilsbiburg (DE)

(72) Inventors: Wolfgang FISCHER, Dorfen (DE); Bernhard HUBER, Eggenfelden (DE)

(73) Assignee: Lisa Draexlmaier GmbH

(21) Appl. No.: 15/614,869

(22) Filed: Jun. 6, 2017

(30) Foreign Application Priority Data
Jun. 6, 2016 (DE) 10 2016 110 394.2

(51) Int. Cl. C08B 37/16; C08L 23/04

(52) U.S. Cl. CPC C08B 37/0012; C08L 23/04

(57) ABSTRACT

Embodiments of the present disclosure provide a method of increasing the surface energy of a polymer, the method comprising adding cyclodextrin to the polymer, wherein the polymer has a surface energy ranging from 1 to 100 mN/m when measured at 20° C.

### CROSS REFERENCE TO RELATED APPLICATION

This application is based upon and claims the benefit of prior German Patent Application No. 10 2016 110 394.2, filed on Jun. 6, 2016, the entire contents of which are incorporated herein by reference.

### TECHNICAL FIELD

The present disclosure relates to the use of cyclodextrins to increase the surface energy in polymer plastics.

### BACKGROUND

Innovative product surfaces and ongoing progress in replacing mechanical joining processes with new adhesives and adhesive techniques, and/or using combined joining processes has resulted in new demands on the corresponding adhesive bonds. Specifically, substrate surfaces with low surface energy present a special challenge, calling for special demands on the materials intended for the adhesion. While there are numerous known and commercially available pressure-sensitive adhesives, they suffer from numerous disadvantages. For example, these adhesives provide inadequate adhesion to low-energy surfaces.

Critical, low-energy surfaces of this kind are encountered on numerous articles of everyday life. The low-energy surfaces are also found on construction elements or assembly components, for example in automotive engineering, in the furniture industry, and the construction industry. In addition to polypropylenes and polyethylenes (PE), such as HDPE (high-density PE) or LDPE (low-density PE), other materials distinguished by low-energy, nonpolar surfaces include ethylene propylene diene copolymers (EPDM), ethylene vinyl acetates (EVA), polyethyleneterephthalates (PET), polyoxymethylenes (polyformaldehydes, POM), polystyrenes (PS), polytetrafluoroethylenes (PTFE), polybutyleneterephthalates (PBT), polyimides (PI), polyarylsulfones (PAS), phenolic resins or polyurethanes (PUR/PU), etc. Further materials include powder coatings, silicones, fluorocarbon-modified surfaces and ethylene propylene diene rubber, nitrile rubber, silicone rubber or natural rubber.

Some pressure-sensitive adhesives may provide adhesion on low-energy surfaces. These pressure-sensitive adhesives may be based on natural or synthetic rubber, or on polysiloxanes. However, these pressure-sensitive adhesives suffer from a variety of disadvantages. For example, the possibilities for using these pressure-sensitive adhesives are very limited. Rubber-based pressure-sensitive adhesives are sensitive to exposure to oxygen, ozone, and light due to the presence of C═C double bonds. This results in a lack of adequate resistance to aging.

Moreover, pressure-sensitive polysiloxane adhesives are very expensive and cost-prohibitive for most applications. In addition, the adhesion of pressure-sensitive polyacrylate adhesives to low-energy surfaces must be enhanced where applicable by adding tackifiers, such as tackifying resins, and/or plasticizers. However, these types of additions provide unfavorable effects on cohesion, resistance to aging, and temperature stability.

### SUMMARY

Embodiments of the present disclosure increase the adhesive strength of a substrate with a low-energy surface in such a manner that it can enter into an adequately strong adhesive bond with a pressure-sensitive polymer and/or pressure-sensitive adhesives. In some implementations, the low-energy polymer surfaces may be producible at low cost.

According to embodiments of the present disclosure, the surface energy of polymers may be considerably increased through the admixture of cyclodextrins. Embodiments of the present disclosure provide a method of increasing the surface energy of a polymer having a surface energy ranging from 1 to 100 mN/m when measured at 20° C., the method comprising adding cyclodextrin to the polymer.

According to some embodiments, the surface energy of the polymer ranges from 5 to 80 mN/m when measured at 20° C., from 10 to 65 mN/m when measured at 20° C., or from 15 to 50 mN/m when measured at 20° C.

The present disclosure may use cyclodextrins from the prior art.

For example, cyclodextrins with the general formula (I)—where 6≦n≦20 represent a class of organic compounds belonging to the cyclic oligosaccharides.

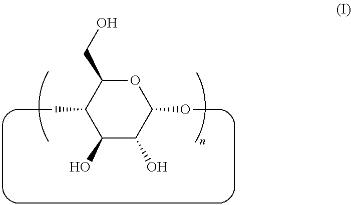

These cyclodextrins consist of α-1,4-glycosidically linked glucose molecules, resulting in a toroidal structure with a central cavity. The cyclodextrins may be derivatized where applicable.

According to embodiments of the present disclosure, cyclodextrins of the general formula (I) may be used. In some embodiments, the integer n ranges from 6 to 15, or ranges from 6 to 9.

According to embodiments of the present disclosure, the cyclodextrins are:

α-cyclodextrin: n=6 glucose molecules,

β-cyclodextrin: n=7 glucose molecules,

γ-cyclodextrin: n=8 glucose molecules,

δ-cyclodextrin: n=9 glucose molecules.

In addition, cyclodextrins with considerably more glucose units are described in the prior art.

Cyclodextrins can be produced enzymatically from starchy raw materials, such as corn or potatoes. The ring-shaped three-dimensional structure forms a hydrophobic cavity in its interior that is capable of receiving a lipophilic molecule as a “guest molecule” in the form of a complex, provided that the lipophilic molecule is compatible in size and shape to the hydrophobic cavity. The vapor pressure of volatile substances may be substantially reduced, for example, by the formation of the complex. According to the prior art, the following effects of complex formation with cyclodextrins are significant for technical applications: stabilization of substances sensitive to light, oxidation, heat, and/or hydrolysis; reduction of the vapor pressure of volatile substances; delay in the release of active agents of active pharmaceutical ingredients and a resultant extended efficacy; increase in solubility and bio-availability of poorly water-soluble substances; separation of individual components from mixtures; and masking odorous and taste substances.

The immobilization of cyclodextrins is known in the prior art, since cyclodextrins are water soluble. Cyclodextrins can accordingly be used as complexing agents. For this purpose, a number of polymers containing cyclodextrins have been synthesized. See, e.g., German Patent Document DE 196 12 768 or WO 97/36948.

For example, Solms and Egli synthesized a resin by cross-linking cyclodextrins with epichlorohydrin. See J. Solms and R. H. Egli, Hel. Chim. Acta 48 (1965), pp. 1225-1228. They succeeded in demonstrating that the cyclodextrins in the resin are accessible to a number of substances.

The production of cyclodextrin polymer foams is known, for example, from Szejtlj et al. (DD 202295). However, polymers were generally synthesized by converting cyclodextrins with epichlorohydrin. The foam was formed by compressing the overpressure of a gas used for foaming into the reaction solution before or during the reaction, and expanding the foam again before curing. Compared to current manufactured polyurethane foams, this method is not industrially applicable because it carried be out in batch operations. Furthermore, the foams produced by Szejtlj et al. have to be neutrally washed after synthesis. In the case of polyurethane foams this is not necessary, nor is it practicable in current manufacturing.

German laying-open specification DE 4009840 discloses the production of cyclodextrin gels that expand in water. However, the synthesis must be viewed as being relatively complex and is too complicated for industrial use. Anhydrous solvents are technically justifiable only in syntheses with a high degree of added value.

Similarly, DE 19612768 (1997) to Huff et al. describes the synthesis for the production of a gel containing cyclodextrin. Here, too, anhydrous solvents must be used.

WO 98/22197 describes the production of polymers containing cyclodextrin that are synthesized among other ways by reaction of cyclodextrins with diisocyanates.

However, while combinations of cyclodextrins with polymers have been described in the prior art, using cyclodextrins to increase the surface energy of low-energy surfaces was not previously known.

According to embodiments of the present disclosure, the surface energy (solid surface energy, or SSE) may be used as a criterion for selection of a suitable adhesive.

Due to their chemical composition, all surfaces have a characteristic polarity and surface tension/surface energy. The surface tension is caused by the striving of liquids to reduce the surface to a minimum, in other words, to form drops. If a surface to be adhered (i.e. a substrate) is moistened with an adhesive, then in addition to the adhesive formulation and the surface properties (for example, material, roughness, moisture, etc.), the surface energy may also be a decisive factor in the maximum achievable adhesive force of the adhesive. A basic rule may be that the surface energy of the adhesive should be lower than that of the material (i.e. the substrate) to be glued. Accordingly, satisfactory adhesion may be improved by raising the surface energy of the substrate.

The values of high-energy surfaces, such as those of metals, are generally greater than 800 mN/m. However, in the case of an apolar substrate, such as polytetrafluoroethylene (PTFE, brand-name Teflon®), the values of high-energy surfaces lie lower by a factor of approximately 40. Even in the case of polymers with functional groups in the polymer structure, such as polyester (PET), polyimides (PI), polyarylsulfones (PAS), or phenolic resins or polyurethanes (PUR/PU), the solid surface energy (SSE) may still range from 41 to 43 mN/m.

According to embodiments of the present disclosure, plastics with low-energy surfaces may be defined as being polymers, copolymers, and polymer mixtures that have a surface energy ranging from 5 to 80 mN/m (measured at 20° C.). In some embodiments, these plastics have a surface energy ranging from 10 to 65 mN/m or ranging from 15 to 50 mN/m.

According to embodiments of the present disclosure, low-energy polymers or copolymers with a surface energy lying in the above-given ranges may include at least one of the following: ethylene propylene diene rubber (EPDM), ethylene vinyl acetate (EVA), natural rubber (NR), nitrile rubber (NBR), linear polyethylene (PE), branched polyethylene (PE), isotactic polypropylene (PP), polyisobutylene (PIB), polystyrene (PS), poly-□-methyl styrene (PMS or polyvinyltoluene PVT), polyvinyl fluoride (PVF), polyvinylidene flouride (PVDF) polytrifluoroethylene (P3FEt/PTrFE), polyvinyl chloride (PVC), polyvinylidene chloride (PVDC), polychlorotrifluoroethylene (PCTrFE), polyvinylacetate (PVA), polymethylacrylate (polymethacrylic acid, PMAA), polyethylacrylate (PEA), polymethylmethacrylate (PMMA), polyethylmethacrylate (PEMA), polybutylmethacrylate (PBMA), polyisobutylmethacrylate (PIBMA), poly(tert-butylmethacrylate (PtBMA), polyhexylmethacrylate (PHMA), polyethylene oxide (PEO), polytetramethylene oxide (PTME) or polytetrahydrofurane (PTHF), polyethyleneterephthalate (PET), polyimide-6,6 (PA-66), polyamide-12 (PA-12), polydimethylsiloxane (PDMS), polycarbonate (PC), polyetheretherketone (PEEK), polyethylene (PE), high-density polyethylene (HDPE), low-density polyethylene (LDPE), polyoxymethylene (polyformaldehyde, polyacetal) (POM), polybutyleneterephthalate (PBT) and silicone rubber (MVQ), in addition to the polymers/copolymers already discussed above.

According to embodiments of the present disclosure, the polymer plastics, having one or more cyclodextrins added, may also contain stabilizers (if applicable) to keep the physical properties of the mixture constant. These stabilizers should not negatively influence the surface energy-enhancing effect of the cyclodextrins. For example, the following stabilizing additives may be used: phosphoric acid, phosphorous acid and toluenesulfonyl isocyanate. Ordinarily, 0 to 0.5%, or 0.01 to 0.1% by weight of the stabilizer is used, depending on the system to be stabilized and on the stabilizer.

According to embodiments of the present disclosure, the polymers, copolymers or polymer mixtures may contain UV stabilizers or temperature stabilizers.

According to embodiments of the present disclosure, the curing reaction may be accelerated, depending on the polymerization method, by the addition of radical starters or catalysts. Some examples in the case of polyurethanes would be diorganotin compounds, such as dibutyltin dilaurate or a mercaptotin compound. The amount used generally ranges, for example, from 0 to 1.5%, in particular from 0.5 to 1% by weight referred to the weight of the prepolymer.

According to embodiments of the present disclosure, the polymer plastics can contain dyes. For example, the polymer component and the polyisocyanate component may have different colors, such that the desired mixture may be determined during the mixing procedure by observing the mixed color, thus safeguarding against applying only one component or inadvertently doubling the amount of the second component added (such as a hardener).

According to embodiments of the present disclosure, the additives should not negatively influence the surface energy-enhancing effect of the cyclodextrins at all, or if so, then only slightly.

### DETAILED DESCRIPTION

Accordingly, embodiments of the present disclosure provide methods of increasing the surface energy of a low-energy polymer comprising adding cyclodextrin to the polymer.

Embodiments of the present disclosure provide a method of increasing the surface energy of a low-energy polymer comprising adding cyclodextrin to the polymer, wherein the polymer has a solid surface energy ranging from 1 to 100 mN/m when measured at 20° C.

Embodiments of the present disclosure provide a method of increasing the surface energy of a low-energy polymer comprising adding cyclodextrin to the polymer, wherein the polymer has a solid surface energy ranging from 5 to 80 mN/m when measured at 20° C.

Embodiments of the present disclosure provide a method of increasing the surface energy of a low-energy polymer comprising adding cyclodextrin to the polymer, wherein the low-energy polymer has a solid surface energy ranging from 10 to 65 mN/m when measured at 20° C.

Embodiments of the present disclosure provide a method of increasing the surface energy of a low-energy polymer comprising adding cyclodextrin to the polymer, wherein the polymer comprises at least one selected from the following group: ethylene propylene diene rubber (EPDM), low-energy ethylene vinyl acetate (EVA), natural rubber (NR), nitrile rubber (NBR), linear polyethylene (PE), branched polyethylene (PE), isotactic polypropylene (PP), polyisobutylene (PIB), polystyrene (PS), poly-␣-methyl styrene (PMS or polyvinyltoluene PVT), polyvinyl fluoride (PVF), polyvinylidene flouride (PVDF) polytrifluoroethylene (P3FEt/PTrFE), polytetrafluoroethylene (PTFE) (Teflon®), polyvinyl chloride (PVC), polyvinylidene chloride (PVDC), polychlorotrifluoroethylene (PCTrFE), polyvinylacetate (PVA), polymethylacrylate (polymethacrylic acid, PMAA), polyethylacrylate (PEA), polymethylmethacrylate (PMMA), polyethylmethacrylate (PEMA), polybutylmethacrylate (PBMA), polyisobutylmethacrylate (PIBMA), poly(tert-butylmethacrylate) (PtBMA), polyhexylmethacrylate (PHMA), polyethylene oxide (PEO), polytetramethylene oxide (PTME) or polytetrahydrofurane (PTHF), polyethyleneterephthalate (PET), polyamide-6,6 (PA-66), polyamide-12 (PA-12), polydimethylsiloxane (PDMS), polycarbonate (PC), polyetheretherketone (PEEK), polyethylene (PE), high-density polyethylene (HDPE), polyarylsulfones (PAS), low-density polyethylene (LDPE), polyimide (PI), polyoxymethylene (polyformaldehyde, polyacetal) (POM), polybutyleneterephthalate (PBT) and silicone rubber (MVQ).

Embodiments of the present disclosure provide a method of increasing the surface energy of a low-energy polymer comprising adding cyclodextrin to the polymer, wherein the cyclodextrin is a cyclical oligosaccharide of α-1,4-linked glucose molecules of the general formula (I),

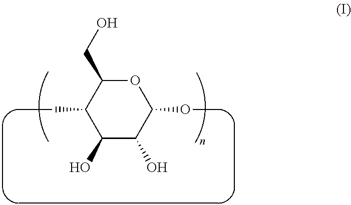

where n is an integer ranging from 6 to 20.

According to embodiments of the present disclosure, n in the general formula (I) is an integer ranging from 6 to 15.

According to embodiments of the present disclosure , n in the general formula (I) is an integer ranging from 6 to 9.

Embodiments of the present disclosure provide a method of increasing the surface energy of a low-energy polymer comprising adding cyclodextrin to the polymer, wherein the cyclodextrin is present in the form of particles having a particle size ranging from 0.1 to 50 μm.

Embodiments of the present disclosure provide a method of increasing the surface energy of a low-energy polymer comprising adding cyclodextrin to the polymer, wherein the cyclodextrin is present in the form of particles having a particle size ranging from 10 to 30 μm.

Embodiments of the present disclosure provide a method of increasing the surface energy of a low-energy polymer comprising adding cyclodextrin to the polymer, wherein the cyclodextrin is present in the form of particles with a particle size ranging from 15 to 25 μm.

Embodiments of the present disclosure provide a method of increasing the surface energy of a low-energy polymer comprising adding cyclodextrin to the polymer , wherein the weight ratio of polymer to cyclodextrin ranges from 90.000 to 99.999 percent by weight to 0.001 to 10 percent by weight.

Embodiments of the present disclosure provide a method of increasing the surface energy of a low-energy polymer comprising adding cyclodextrin to the polymer, wherein the weight ratio of polymer to cyclodextrin ranges from 92.5 to 99.99 percent by weight to 0.01 to 7.5 percent by weight.

Embodiments of the present disclosure provide a method of increasing the surface energy of a low-energy polymer comprising adding cyclodextrin to the polymer, wherein the weight ratio of polymer to cyclodextrin lies ranges from 95.0 to 99.9 percent by weight to 0.1 to 5.0 percent by weight.

Having described aspects of the present disclosure in detail, it will be apparent that modifications and variations are possible without departing from the scope of aspects of the present disclosure as defined in the appended claims. As various changes could be made without departing from the scope of aspects of the present disclosure, it is intended that all matter contained in the above description shall be interpreted as illustrative and not in a limiting sense.

1-14. (canceled)

15. A method of increasing the surface energy of a polymer, the method comprising adding cyclodextrin to the polymer, wherein the polymer has a surface energy ranging from 1 to 100 mN/m when measured at 20° C.

16. The method according to claim 15, wherein the polymer has a surface energy ranging from 5 to 80 mN/m when measured at 20° C.

17. The method according to claim 15, wherein the polymer has a surface energy ranging from 10 to 65 mN/m when measured at 20° C.

18. The method according to claim 15, wherein the polymer has a surface energy ranging from 15 to 50 mN/m when measured at 20° C.

19. The method according to claim 15, wherein the polymer comprises at least one selected from the following group: ethylene propylene diene rubber (EPDM), low-energy ethylene vinyl acetate (EVA), natural rubber (NR), nitrile rubber (NBR), linear polyethylene (PE), branched polyethylene (PE), isotactic polypropylene (PP), polyisobutylene (PIB), polystyrene (PS), poly-alpha-methylstyrene (PMS, or polyvinyltoluene PVT), polyvinyl fluoride (PVF), polyvinylidene flouride (PVDF), polytrifluoroethylene (P3FEt/PTrFE), polytetrafluoroethylene (PTFE) (Teflon®), polyvinyl chloride (PVC), polyvinylidene chloride (PVDC), polychlorotrifluoroethylene (PCTrFE), polyvinylacetate (PVA), polymethylacrylate (polymethacrylic acid (PMAA), polyethylacrylate (PEA), polymethylmethacrylate (PMMA), polyethylmethacrylate (PEMA), polybutylmethacrylate (PBMA), polyisobutylmethacrylate (PIBMA), poly(tert-butylmethacrylate) (PtBMA), polyhexylmethacrylate (PHMA), polyethylene oxide (PEO), polytetramethylene oxide (PTME) or polytetrahydrofurane (PTHF), polyethyleneterephthalate (PET), polyimide-6,6 (PA-66), polyimide-12 (PA-12), polydimethylsiloxane (PDMS), polycarbonate (PC), polyetheretherketone (PEEK), polyethylene (PE), high-density polyethylene (HDPE), low-density polyethylene (LDPE), polyarylsulfone (PAS), polyester, polyimide (PI), polyoxymethylene (polyformaldehyde, polyacetal (POM)), polybutyleneterephthalate (PBT) and silicone rubber (MVQ).

20. The method according to claim 15, wherein the cyclodextrin is a cyclical oligosaccharide of alpha-1,4-linked glucose molecules of the general formula I, 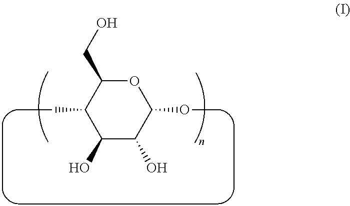
wherein n is an integer ranging from 6 to 20.

21. The method according to claim 20, wherein n ranges from 6 to 15.

22. The method according to claim 20, wherein n ranges from 6 to 9.

23. The method according to claim 15, wherein the cyclodextrin is present in the form of particles having a particle size ranging from 0.1 to 50 μm.

24. The method according to claim 23, wherein the particle size ranges from 10 to 30 μm.

25. The method according to claim 23, wherein the particle size ranges from 15 to 25 μm.

26. The method according to claim 15, wherein the weight ratio of polymer to cyclodextrin ranges from 90.000 to 99.999 percent by weight to 0.001 to 10 percent by weight.

27. The method according to claim 15, wherein the weight ratio of polymer to cyclodextrin ranges from 92.5 to 99.99 percent by weight to 0.01 to 7.5 percent by weight.

28. The method according to claim 15, wherein the weight ratio of polymer to cyclodextrin ranges from 95.0 to 99.9 percent by weight to 0.1 to 5.0 percent by weight.

29. The method according to claim 15, wherein the polymer comprises a low-energy polymer.
